(19) United States
(12) Patent Application Publication
(10) Pub. No.: US 2020/0024114 A1
(43) Pub. Date: Jan. 23, 2020

(54) VEHICLE-MOUNTED DEVICE, CARGO HANDLING MACHINE, CONTROL CIRCUIT, CONTROL METHOD, AND PROGRAM THEREOF

(71) Applicant: NEC CORPORATION, Tokyo (JP)

(72) Inventors: Jun UCHIMURA, Tokyo (JP); Hideaki TAKAHASHI, Tokyo (JP)

(73) Assignee: NEC CORPORATION, Tokyo (JP)

(21) Appl. No.: 16/491,385

(22) PCT Filed: Feb. 28, 2018
(86) PCT No.: PCT/JP2018/007468

§ 371 Date: Sep. 5, 2019

(30) Foreign Application Priority Data
Mar. 22, 2017 (JP) 2017-056012

(51) Int. Cl. B66F 9/075; B66F 9/16; B66F 9/06; B66F 9/24; G05D 1/02

(52) U.S. Cl. CPC B66F 9/0755; B66F 9/16; B66F 9/063; G05D 2201/0216; G05D 1/0225; G05D 1/024; B66F 9/24

(57) ABSTRACT

A vehicle-mounted device includes an analysis unit and a control unit. The analysis unit detects an insertion blade on the basis of sensing information acquired from a spatial recognition device, and calculates an insertion distance indicating a distance by which the detected insertion blade is inserted into an insertion target. The control unit performs an amount-of-insertion determination to determine whether or not the insertion distance is in a predetermined range.

### TECHNICAL FIELD

The present invention relates to a vehicle-mounted device, a cargo handling machine, a control circuit, a control method, and a program hereof.

### BACKGROUND ART

In recent years, with the development of automatic driving technology and robot technology, the accuracy of spatial recognition technology utilizing a laser or a radar has been improved, and the price of spatial recognition sensors has reduced.

On the other hand, a device that manages cargo handling work is used in a cargo handling machine such as a forklift. For example, Patent Document 1 describes notifying that a distance to a pallet is in a range of an optimal distance obtained from a length of a fork and a depth of the pallet.

### DOCUMENTS OF THE PRIOR ART

### Patent Document

[Patent Document 1] Japanese Unexamined Patent Application, First Publication No. 07-101696

### SUMMARY OF INVENTION

### Problems to be Solved by the Invention

However, in a technology described in Patent Document 1, only the distance to the pallet is detected, and the length of the fork and the depth of the pallet need to be fixed or the optimal distance according to the length of the fork and the depth of the pallet must be set in advance. For example, when the length of the fork and the depth of the pallet are different from assumed values or when a setting is incorrect, an inappropriate distance is determined to be an optimal distance in the technology described in Patent Document 1.

When the optimal distance is wrong, there is a problem that cargo to be transported (a transport target) or a transport target therein may be reversed, dropped, or damaged due to insufficient insertion or excessive insertion of the fork.

As described above, in the technology described in Patent Document 1, there is a problem that it is not possible to prevent the transport target from being reversed, dropped, or damaged and to transport the transport target appropriately.

Therefore, an object of an aspect of the present invention is to provide a vehicle-mounted device, a cargo handling machine, a control circuit, a control method, and a program capable of appropriately transporting a transport target.

### Means for Solving the Problems

As an aspect of the present invention that has been made to solve the above-described problems, a vehicle-mounted device is provided including: an analysis unit that detects an insertion blade on the basis of sensing information acquired from a spatial recognition device and calculates an insertion distance indicating a distance by which the detected insertion blade has been inserted into an insertion target; and a control unit that performs an amount-of-insertion determination to determine whether or not the insertion distance is in a predetermined range.

Further, an aspect of the present invention is a cargo handling machine including the above-described vehicle-mounted device.

Further, an aspect of the present invention is a control circuit that detects an insertion blade on the basis of sensing information acquired from a spatial recognition device, and determines whether or not an insertion distance indicating a distance by which the detected insertion blade is inserted into the insertion target is a predetermined range.

Further, an aspect of the present invention is a control method including: detecting, by an analysis unit, an insertion blade on the basis of sensing information acquired from a spatial recognition device, and calculating an insertion distance indicating a distance by which the detected insertion blade is inserted into an insertion target; and performing, by a control unit, an amount-of-insertion determination to determine whether or not the insertion distance is in a predetermined range.

Further, an aspect of the present invention is a program causing a computer to: detect an insertion blade on the basis of sensing information acquired from a spatial recognition device; calculate an insertion distance indicating a distance by which the detected insertion blade is inserted into an insertion target; and perform an amount-of-insertion determination to determine whether or not the insertion distance is in a predetermined range.

### Advantageous Effects of the Invention

According to the aspects of the present invention, it is possible to appropriately transport the transport target.

### BRIEF DESCRIPTION OF THE DRAWINGS

FIG. 1 is a perspective view illustrating transport work according to an embodiment of the present invention.

FIG. 2 is a front view illustrating an example of a fixed position of a work management device according to the embodiment.

FIG. 3 is a schematic diagram illustrating an example of sensing according to the embodiment.

FIG. 4 is a side view illustrating an example of sensing according to the embodiment.

FIG. 5 is a schematic diagram illustrating an example of a sensing result according to the embodiment.

FIG. 6 is a diagram illustrating an example of a process of calculating a target distance according to the embodiment.

FIG. 7A is a schematic diagram illustrating an example of insertion distance estimation according to the embodiment and is a diagram illustrating a reaching distance of a fork of a forklift.

FIG. 7B is a schematic diagram illustrating an example of insertion distance estimation according to the embodiment and is a diagram illustrating the insertion distance of the fork of the forklift.

FIG. 8A is a schematic diagram illustrating an example of an amount-of-insertion determination according to the embodiment and is a diagram illustrating a case in which the amount of insertion of the fork is appropriate.

FIG. 8B is a schematic diagram illustrating an example of the amount-of-insertion determination according to the embodiment and is a diagram illustrating a case in which the amount of insertion of the fork is inappropriate.

FIG. 9A is a schematic diagram illustrating another example of the amount-of-insertion determination according to the embodiment and is a diagram illustrating a case in which the amount of insertion of the fork is appropriate.

FIG. 9B is a schematic diagram illustrating another example of the amount-of-insertion determination according to the embodiment and is a diagram illustrating a case in which the amount of insertion of the fork is inappropriate.

FIG. 10 is a flowchart illustrating an example of an operation of the forklift according to the embodiment.

FIG. 11 is a block diagram illustrating a hardware configuration of the work management device according to the embodiment.

FIG. 12 is a schematic block diagram illustrating a logical configuration of the work management device according to the embodiment.

FIG. 13 is another schematic block diagram illustrating the logical configuration of the work management device according to the embodiment.

FIG. 14A is a schematic diagram illustrating an example of an amount-of-insertion determination according to a modification example of the embodiment and is a diagram illustrating a positional relationship between a fork and an insertion surface of a container at a timing when the fork has reached the insertion surface of the container.

FIG. 14B is a schematic diagram illustrating an example of the amount-of-insertion determination according to the modification example of the embodiment, and is a diagram illustrating a positional relationship between the fork and the insertion surface of the container at a timing after the fork has reached the insertion surface of the container.

### EMBODIMENTS FOR CARRYING OUT THE INVENTION

Hereinafter, embodiments of the present invention will be described in detail with reference to the drawings.

### <Transport Work>

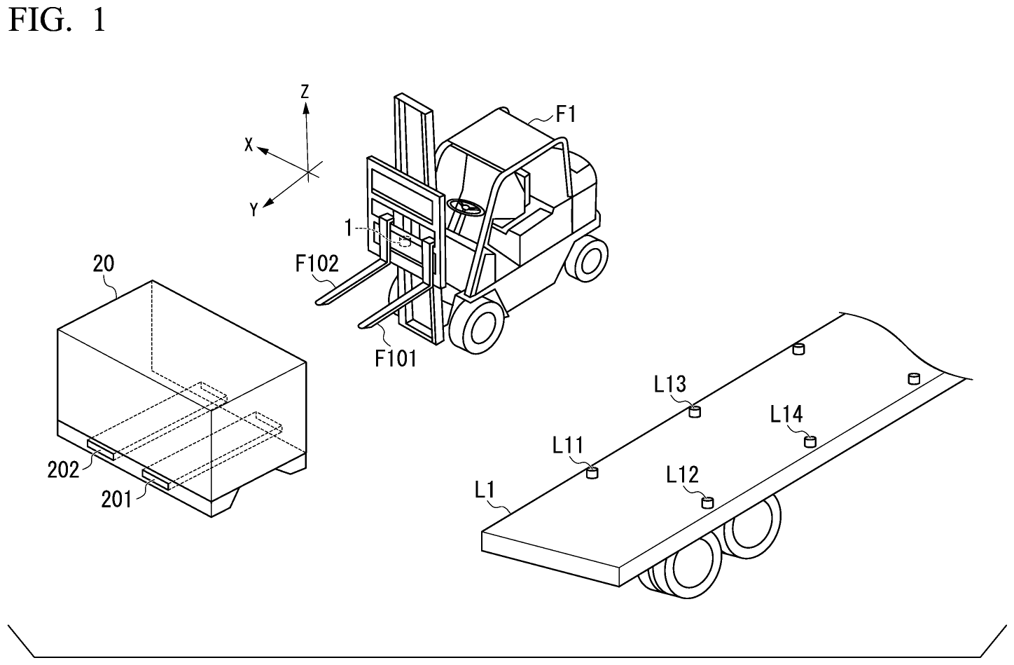

FIG. 1 is an illustrative diagram illustrating a transport work according to an embodiment of the present invention. A forklift F1 is an example of a cargo handling machine. Forks F101 and F102 are provided in the forklift F1. The forks F101 and F102 are examples of insertion blades.

The forklift F1 grips and transports a transport target such as a load or a pallet by inserting the forks F101 and F102 into the transport target. That is, the insertion blade that grips the transport target by being inserted into the transport target is provided in the cargo handling machine.

A container 20 is an example of the transport target or an insertion target. The container 20 is a container for storing cargo or the like therein. Openings (insertion portions; may be concave portions) of the fork pockets 201 and 202 are provided in the container 20. The fork pockets 201 and 202 are holes or concave portions into which the forks F101 and F102 are inserted, respectively. The fork pockets 201 and 202 are an example of insertion targets.

A surface facing the forklift F1 (also referred to as an “insertion surface 211”) at the time of the insertion or the transport has the fork pockets 201 and 202. The fork pockets 201 and 202 are holes or concave portions in which the forks F101 and F102 are inserted from a front surface (an insert surface 211) to a back surface (a positive direction of a Y axis in FIG. 1) of the transport target, and that have distal end portions projecting from a back surface.

In FIG. 1, the fork pockets 201 and 202 are holes extending straight in a normal direction of the insertion surface 211 in a lower portion of the insertion surface 211.

When the forks F101 and F102 are inserted straight into the fork pockets 201 and 202, respectively, the forklift F1 can grip the container 20 appropriately (with a good balance and stability) and transport the container 20.

It should be noted that a dimension or the like of the container 20 or the fork pockets 201 and 202 is defined by a standard (for example, JIS). Further, the transport target is not limited to the container 20, may be a pallet, or may be both of the pallet and cargo placed on the pallet. Here, the pallet refers to a cargo handling platform for loading the cargo. The fork pockets are provided in the pallet. Further, there may be three or more (for example, four) fork pockets.

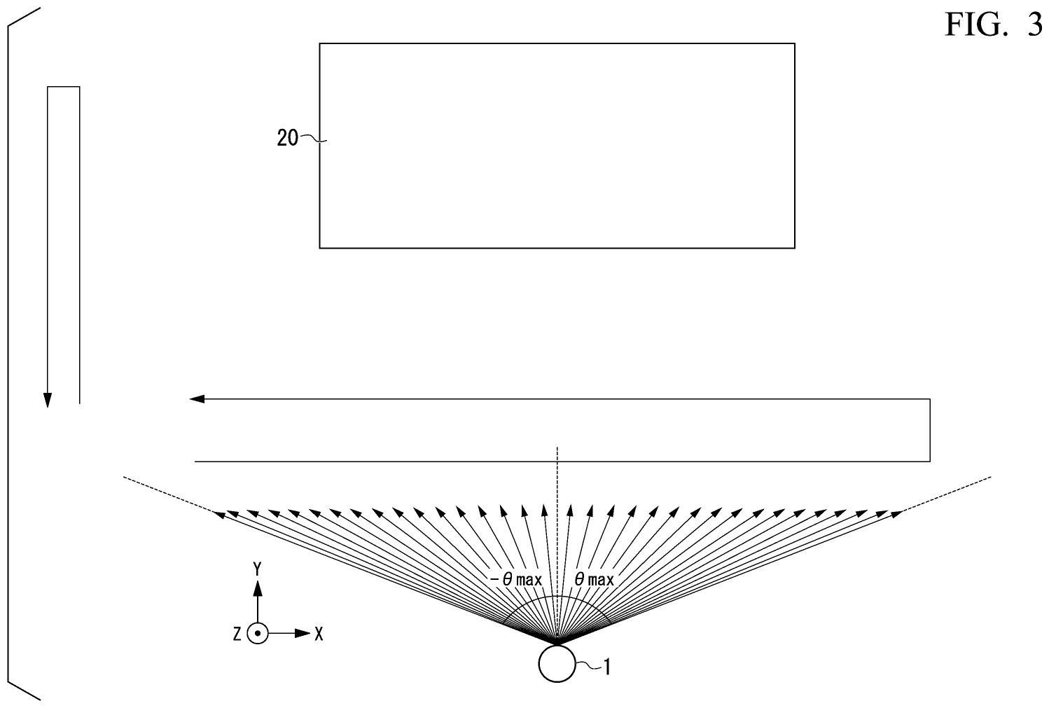

A work management device 1 is attached and fixed to a cargo handling machine. The work management device 1 includes, for example, a spatial recognition sensor such as a laser sensor. A case in which the spatial recognition sensor is a laser sensor will be described in the embodiment. That is, the work management device 1 (a spatial recognition sensor) radiates laser light, receives reflected light, and senses a distance R from the work management device 1 to each object. The work management device 1 repeats this for a range of a sensing target. The work management device 1 recognizes a space, for example, according to an irradiation direction of the laser light and the distance R to each object (see FIGS. 3 to 6).

The work management device 1 detects the container 20 (or the insertion surface 211) on the basis of sensing information obtained from the spatial recognition sensor. The work management device 1 detects the forks F101 and F102 on the basis of the sensing information, and calculates the distance dₚ by which the detected forks F101 and F102 are inserted into the container 20 (or fork pockets 201 and 202). Hereinafter, this distance dₚ is also referred to as an “insertion distance dₚ”, and calculation of the distance dₚ is also referred to as “insertion distance estimation”.

The work management device 1 performs an amount-of-insertion determination to determine whether or not the calculated insertion distance dₚ is in a predetermined range. The work management device 1 outputs a determination result. For example, when the insertion distance dₚ is not in the predetermined range, that is, when the forks F101 and F102 are inserted too much, or when the insertion of the forks F101 and F102 is insufficient, the work management device 1 performs an output indicating the fact (for example, a warning sound, warning light, warning image, guidance).

Accordingly, the work management device 1, for example, can notify a worker or the like that the forks F101 and F102 are inserted too much into the fork pockets 201 and 202 or the insertion of the forks F101 and F102 is insufficient (referred simply to an “amount of insertion is inappropriate”. When the insertion is insufficient, the forklift F1 cannot appropriately grip the container 20 in a case in which the forklift F1 grips the container 20, or a balance of the container 20 is likely to be lost and the container 20 is likely to be dropped. Further, when the forks F101 and F102 are inserted too much, an object (for example, another container) inside the container 20 is likely to be damaged or reversed. That is, it is not possible to appropriately transport the transport target.

The worker or the like can change a degree of insertion of the forks F101 and F102 according to the warning.

As a result, the worker or the like can insert the forks F101 and F102 into the fork pockets 201 and 202 by an appropriate amount. That is, the forklift F1 can grip the container 20 appropriately (with a good balance and stability) and transport the container 20, and can prevent the container 20 from being dropped. Further, the forklift F1 can prevent an object (such as another container) inside the container 20 from being damaged or reversed.

It should be noted that, when the insertion distance dₚ is in a predetermined range, that is, when the forks F101 and F102 are appropriately inserted (also referred to simply as “the amount of insertion is appropriate”), the work management device 1 may perform an output indicating the fact.

A loading platform L1 is an example of a carrying-out destination. The loading platform L1 is a loading platform for a truck or a trailer, a freight car for a freight train, or the like. Tightening devices L11 to L14 are provided in the loading platform L1. The tightening device is a device that is used to connect or fix the container 20.

The container 20 is gripped and transported by the forklift F1, placed on the loading platform L1, and fixed to the loading platform L1 by the tightening devices L11 to L14.

It should be noted that coordinate axes X, Y, and Z illustrated in FIG. 1 are common coordinate axes in the respective drawings of the embodiment and a modification example thereof.

### <Forklift>

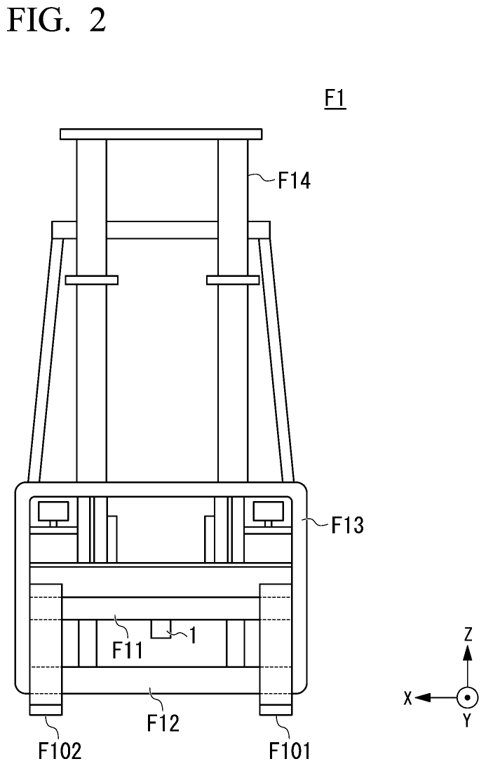

FIG. 2 is a schematic diagram illustrating an example of a fixed position of the work management device 1 according to the embodiment.

FIG. 2 is a front view of the forklift F1.

Fork rails F11 and F12 (finger bars) are rails for attaching the forks F101 and F102. It should be noted that the fork F101 or the fork F102 are slid along the fork rails F11 and F12 such that an interval between the fork F101 and the fork F102 can be adjusted.

A backrest F13 is attached to the fork rails F11 and F12. The backrest F13 is a mechanism that prevents the gripped container 20 from collapsing or being dropped to the forklift F1.

A mast F14 is a rail for moving the forks F101 and F102 up and down. When the fork rails F11 and F12 are moved up and down along the mast F14, the forks F101 and F102 are moved up and down.

The work management device 1 is fixed to a central portion (in the X-axis direction) of the fork rail F11 , which is the lower surface side (the lower side) of the fork rail F11 . However, the work management device 1 may be attached to the upper surface side (the upper side) of the fork rail F11 or the like. Further, the work management device 1 may be attached to the fork rail F12, the backrest F13, the mast F14, or a vehicle body of the forklift F1. Further, a plurality of work management devices 1 or spatial recognition sensors may be attached.

It should be noted that when the work management device 1 is fixed to the fork rail F11 , the fork rail F12, and the backrest F13, the container 20 can be irradiated with the laser light without the laser light radiated by the spatial recognition device being blocked. In this case, since the fork rail F11 , the fork rail F12, and the backrest F13 move up and down together with the forks F101 and F102 or the container 20, a relative positional relationship between these and the work management device 1 can be fixed.

### <Sensing>

Hereinafter, sensing in the work management device 1 (a spatial recognition sensor) will be described.

It should be noted that, in the embodiment, a laser light irradiation scheme in a case in which the work management device 1 performs raster scanning will be described, but the present invention is not limited thereto and another irradiation scheme (for example, Lissajous scan) may be used.

FIG. 3 is a schematic diagram illustrating an example of sensing according to the embodiment.

FIG. 3 is a diagram in a case in which sequentially radiated laser light is viewed from the upper surface side of the forklift F1. It should be noted that, in FIG. 3, an angle (a polar angle of polar coordinates) in a case in which projection onto an XY plane is performed in a projection direction of the laser light is set to θ. An axis (an initial optical axis to be described below) that is an axis parallel to a Y axis and passing through the work management device 1 (an irradiation port) is set to θ=0.

The work management device 1 performs scanning in a horizontal direction (with other polar angles ϕ made constant) by sequentially radiating the laser light in the horizontal direction.

More specifically, the work management device 1 radiates the laser light sequentially (for example, at each equal angle Δθ) in a positive direction of the polar angle θ. The work management device 1 irradiates a specific range in the horizontal direction (a range in which a polar angle projected on an XY plane is −θmax≤θ≤θmax) with the laser light (also referred to as “horizontal scanning”), shifts an irradiation direction of the laser light in the vertical direction, and then, radiates the laser light in the negative direction of the polar angle θ.

When the horizontal scanning in the negative direction of the polar angle θ is completed, the work management device 1 further shifts the irradiation direction of the laser light in the vertical direction, and performs the horizontal scanning in the positive direction of the X axis again.

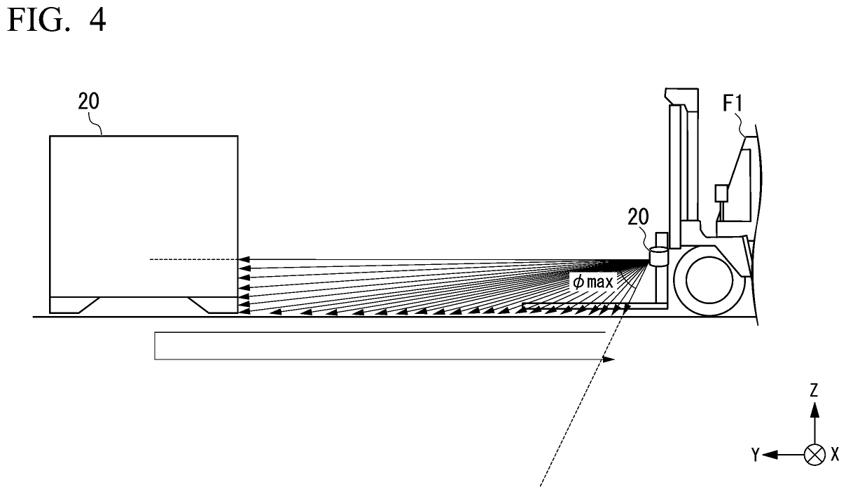

FIG. 4 is another schematic diagram illustrating an example of sensing according to the embodiment.

FIG. 4 is a diagram in a case in which irradiation with the laser light is viewed from the side surface of the forklift F1. It should be noted that horizontal scanning in FIG. 3 corresponds to one of arrows in FIG. 4.

In FIG. 4, an angle (a polar angle of polar coordinates) when projection onto a YZ plane is performed in the projection direction of the laser light is set to ϕ. An axis (an initial optical axis) that is an axis parallel to a Y axis and passing through the work management device 1 (an irradiation port) is set to ϕ=0.

The work management device 1 shifts the laser light by an equal angle Δϕ in a direction of the polar angle ϕ for each horizontal scanning. More specifically, the work management device 1 performs horizontal scanning in a positive direction of the polar angle 0, and then, shifts the irradiation direction of the laser light by the equal angle Δϕ in the positive direction of the polar angle ϕ. Thereafter, the work management device 1 performs horizontal scanning in the negative direction of the polar angle θ, and then, further shifts the irradiation direction of the laser light by the equal angle Δϕ in the positive direction of the polar angle ϕ.

The work management device 1 repeats this operation and irradiates a specific range (for example, range of −ϕmax (for example, ϕmax=90°)≤ϕ≤0) in the positive direction of the polar angle ϕ. It should be noted that the work management device 1 may reverse the irradiation in the negative direction of the polar angle ϕafter shifting the irradiation by the specific range (ϕ=0).

It should be noted that the work management device 1 may radiate the laser light in another order or another coordinate system.

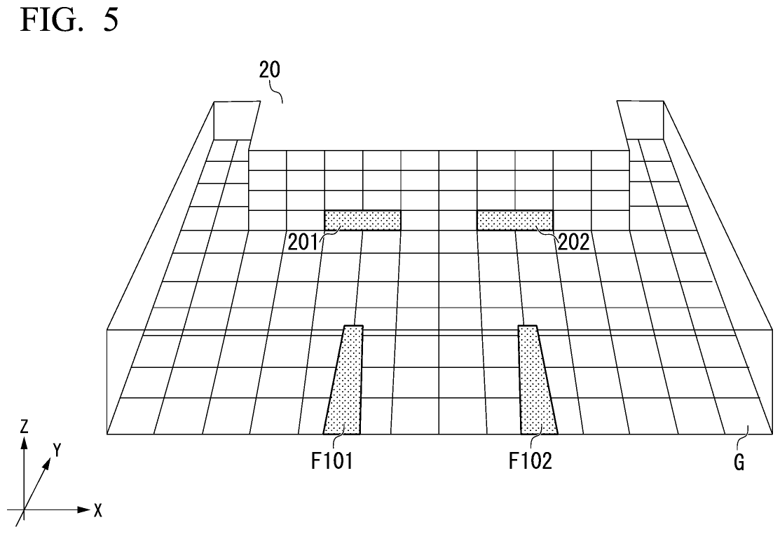

FIG. 5 is a schematic diagram illustrating an example of a sensing result according to the embodiment.

FIG. 5 illustrates sensing information indicating the sensing result in an example of the sensing in FIGS. 3 and 4. The sensing information is, for example, space coordinates. The work management device 1 calculates this space coordinate on the basis of the irradiation direction (the polar angle θ and the polar angle ϕ) of the laser light and the distance R to a reflection source (an object). The space coordinates are coordinates representing a position of the reflection source in a sensing range. FIG. 5 is a diagram schematically illustrating the space coordinates.

In FIG. 5, the work management device 1 detects the container 20, the fork pockets 201 and 202 of the container 20, and the forks F101 and F102. It should be noted that a surface denoted by reference sign G is a road surface G.

The work management device 1 detects the container 20 (at least a part of the insertion surface 211) and the fork pockets 201 and 202 of the container 20 through a first detection process. In an example of the first detection process, for example, the work management device 1 sets a flat or substantially flat surface (including a surface having unevenness) as a plane and detects a plane standing perpendicularly (in a vertical direction) or substantially perpendicularly to a ground or a floor surface. When the work management device 1 detects the fork pockets 201 and 202 in this plane, the work management device 1 determines that the plane is the insertion surface 211 of the container 20.

Here, the work management device 1, for example, detects, as the fork pockets 201 and 202, a portion in which the reflected light of the laser light is not detected and a portion in which a reception level of the reflected light of the laser light is low in the detected plane or a lower portion of the plane.

It should be noted that the work management device 1 may detect, as the fork pockets 201 and 202, a portion in which a distance equal to or greater than a predetermined value is changed (far away) with respect to a distance to the plane in the detected plane or a lower portion of the plane.

Further, the work management device 1 may detect the fork pockets 201 and 202 from the detected plane using the sensing information and the pocket position information. Here, the pocket position information is information indicating a combination of a dimension of the container 20 and a position or dimension (shape) of the fork pockets 201 and 202 in the container 20, or information indicating a pattern of this combination. That is, for example, when there is a predetermined ratio or more of a portion in which the reception level of the reflected light of the laser light is low, at positions at which there are the fork pockets 201 and 202 on the basis of the pocket position information, the work management device 1 may determine that there are the fork pockets 201 and 202 based on the pocket position information.

The work management device 1 detects the forks F101 and F102 through a second detection process.

In an example of the second detection process, for example, the work management device 1 detects a plane extending a specific length or more in a Y-axis direction among planes parallel or substantially parallel to the XY plane, which is a portion smaller than a specific width in the X-axis direction, as the forks F101 and F102. It should be noted that the work management device 1 may store patterns of positions and shapes of the forks F101 and F102 in advance and detect objects matching the patterns as the forks F101 and F102.

Further, the work management device 1 also calculates lengths (also referred to as “fork lengths”) f1 of the detected forks F101 and F102. The fork length f1 is a length from a base to a distal end of the fork F101 or F102 in the XY plane. However, the present invention is not limited thereto, and the fork length f1 may be a length including the Z-axis direction, or the fork length f1 may be a length having the vicinity of the base or the vicinity of the distal end as one end. The base of the fork F101 or F102 may be a root of the fork F101 or F102, an end, an L-shaped bent portion, a non-flat portion, or a portion at which the fork F101 or F102 and the fork rail F11 or F12 or the backrest F13 intersect in the XY plane.

### <Calculation of Target Distance>

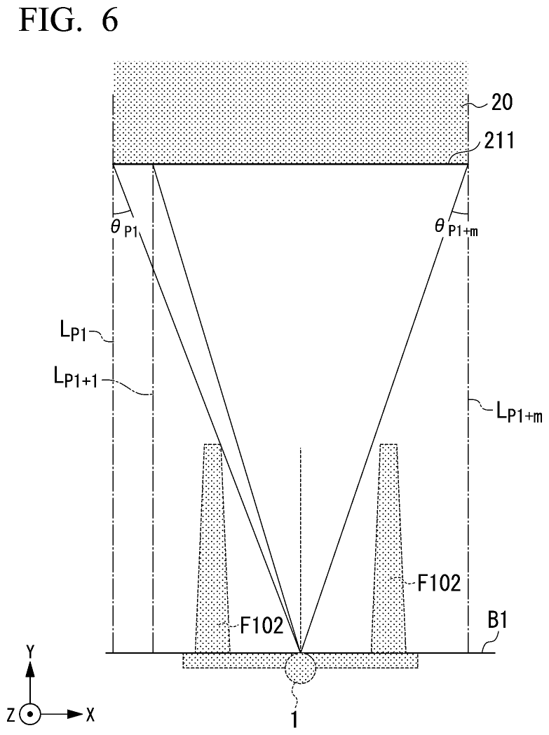

FIG. 6 is a diagram illustrating an example of a process of calculating the target distance LB according to the embodiment.

It should be noted that the target distance LB is a distance from the forklift F1 to the container 20 (the insertion surface 211). Further, the target distance LB may be a distance from a position of the base of the forks F101 and F102 or the vicinity thereof to the openings of the fork pockets 201 and 202.

FIG. 6 is a diagram in a case in which the forklift F1 faces the container 20. That is, when a traveling direction of the forklift F1 (a direction in which the forks F101 and F102 extend) is the Y-axis direction, the traveling direction is a normal direction of the insertion surface 211. FIG. 6 is a diagram in which the sensing information of FIG. 5 is projected onto the XY plane.

In FIG. 6, a solid line indicates laser light. Further, in FIG. 6, the projection of the container 20, the forks F101 and F102, and the work management device 1 is indicated by a broken line for convenience.

In FIG. 6, the work management device 1 detects a plane 211 in a range in which the polar angle θ is −θ_{P1}≤θ≤θ_{P1+m}. It should be noted that i in θᵢ represents an order in which the laser light is radiated in one horizontal scanning, that is, the number of irradiations. For example, θᵢ=−θₘₐₓi×Δθ. The reference surface B1 is a plane parallel to an XZ plane and is a surface perpendicular to a traveling direction when the forklift F1 travels straight. For example, the reference surface B1 is a plane including the work management device 1 (a projection port) in such a plane. The reference surface B1 is located at the base of the forks F101 and F102 or in the vicinity thereof, or at a position of the fork rails F11 and F12 or the backrest F13, the work management device 1, or the spatial recognition sensor or in the vicinity thereof in the projection onto the XY plane.

When the work management device 1 detects the fork pockets 201 and 202 in the detected plane 211, the work management device 1 determines that the plane 211 is the insertion surface (the insertion surface 211) of the container 20.

The work management device 1 calculates a distance Lᵢ (referred to as a “reference distance Lᵢ”) from the reference surface B1 of the forklift F1 to the insertion surface 211 on the basis of a distance Rᵢ from the work management device 1 to the object (the reflection source). Here, the distance Ri represents a distance R detected through the i-th irradiation, which is a distance R from the work management device 1 to the object (the reflection source).

For example, in a case in which an irradiation direction is θᵢ and ϕ, the work management device 1 calculates the reference distance Lᵢ=Rᵢ cos|ϕ|×cos|θᵢ| when the work management device 1 has detected the distance Rᵢ to the object. Here, ϕ represents a polar angle ϕ when the i-th irradiation has been performed.

In FIG. 6 (when the reference surface B1 and the insertion surface 211 completely face each other), the reference distance Lᵢ has the same value in a range of P1≤i≤P1+m. In this case, the work management device 1 sets the reference distance Lᵢ as the target distance LB.

On the other hand, when the reference distance Lᵢ is different, for example, when the reference surface B1 and the insertion surface 211 do not completely face each other, the work management device 1 may set the reference distance Lᵢ that is a minimum value as the target distance LB for the reflected light from the insertion surface 211 or may set an average value of the reference distances Lᵢ as the target distance LB.

Alternatively, the work management device 1 may set the reference distance Lᵢ measured when the irradiation direction is the normal direction of the reference surface B1, that is, when θ=0 and φ=0, as the target distance LB.

It should be noted that the work management device 1 may detect the base of the fork or the vicinity thereof, and calculate a distance from the detected base or vicinity to the insertion surface 211 as the target distance LB.

### <Insertion Distance Estimation>

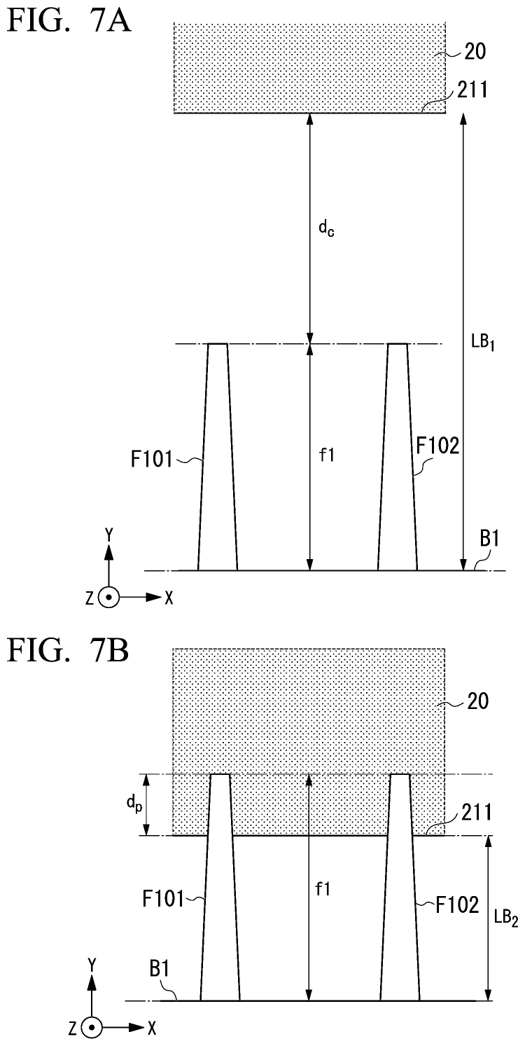

FIGS. 7A and 7B are schematic diagrams illustrating an example of insertion distance estimation according to the embodiment.

The work management device 1 calculates a value d obtained by subtracting the target distance LB from lengths (also referred to as “fork lengths”) f1 of the forks F101 and F102, as the insertion distance dₚ (when the value is positive or 0) or the reaching distance d_{c} (when the value is negative).

Here, the insertion distance dₚ is a distance from the insertion surface 211 (the openings of the fork pockets 201 and 202) to distal ends of the forks F101 and F102 when the forks F101 and F102 are inserted. The reaching distance d_{c} is a distance from the distal ends of the forks F101 and F102 to the insertion surface 211 when the forks F101 and F102 are not inserted.

FIGS. 7A and 7B are diagrams in which sensing information is projected onto the XY plane.

It should be noted that, in FIGS. 7A and 7B, distances LB1 and LB2 are reference distances LB, and a fork length f1 is a length of the forks F101 and F102 (a length in the Y-axis direction).

FIG. 7A illustrates an example of the reaching distance d_{c}, and FIG. 7B illustrates an example of the insertion distance dₚ.

When the forks F101 and F102 are not inserted (in the case of FIG. 7A), the work management device 1 calculates a value obtained by subtracting the fork length f1 from the distance LB1 as the reaching distance d_{c}. On the other hand, when the forks F101 and F102 are inserted (in the case of FIG. 7B), the work management device 1 calculates a value obtained by subtracting the distance LB2 from the fork length f1 as the insertion distance dₚ. It should be noted that the work management device 1 may detect the length f1 or may store the length f1 in advance.

### <Insertion Amount Determination>

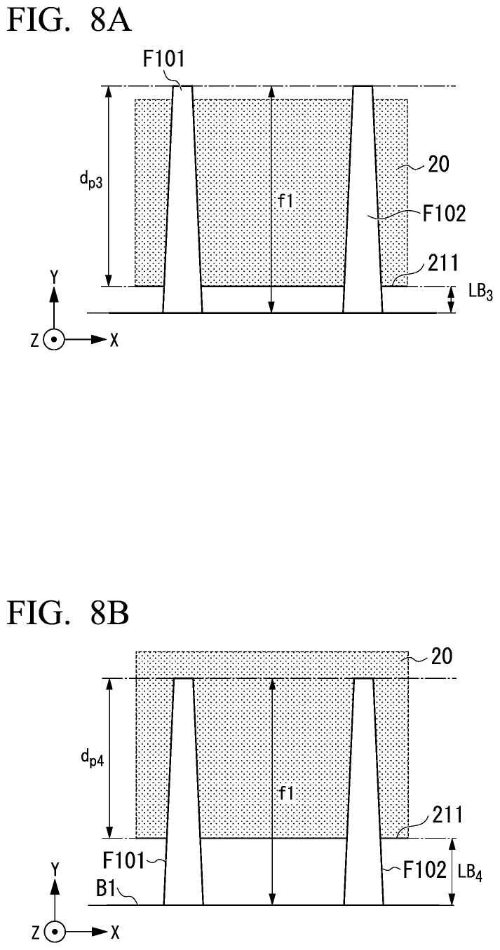

FIGS. 8A and 8B are schematic diagrams illustrating an example of the amount-of-insertion determination according to the embodiment.

FIG. 8A is a diagram in a case in which the amount of insertion is appropriate, and FIG. 8B is a diagram in a case in which the amount of insertion is inappropriate. It should be noted that FIGS. 8A and 8B are diagrams in which the sensing information is projected onto the XY plane. In FIGS. 8A and 8B, distances LB₃ and LB₄ are reference distances LB, and distances dₚ₃ and dₚ₄ are specific examples of the insertion distance dₚ. The fork length f1 is the length of the forks F101 and F102.

The work management device 1 performs a first amount-of-insertion determination below.

When the insertion distance dₚ (see FIG. 8B) is equal to or greater than a threshold value TH1, the work management device 1 determines that the amount of insertion is appropriate. That is, when the insertion distance dₚ is equal to or greater than the threshold value TH1, the work management device 1 determines that the forks F101 and F102 are sufficiently inserted and the container 20 can be appropriately gripped. In this case, the work management device 1 determines that the forks F101 and F102 are allowed to be raised and lowered. For example, the threshold value TH1 is a length of a predetermined proportion (for example, 90%) of the fork length f1, or a length obtained by subtracting a predetermined length (for example, 20 cm) from the fork length f1.

It should be noted that the work management device 1 may determine that the amount of insertion is appropriate when the insertion distance dₚ is equal to or greater than the threshold value TH1 and equal to or smaller than the threshold value TH2 (>TH1). That is, when the insertion distance dₚ is equal to or smaller than the threshold value TH2, the work management device 1 determines that the forks F101 and F102 are not inserted too much and the container 20 can be appropriately gripped. For example, the threshold value TH2 is a length of a predetermined proportion (for example, 95%) of the fork length f1, or a length obtained by subtracting a predetermined length (for example, 5 cm) from the fork length f1.

On the other hand, when the insertion distance dₚ is smaller than the threshold value TH1, the work management device 1 determines that the amount of insertion is inappropriate. That is, when the insertion distance dₚ is smaller than the threshold value TH1, the work management device 1 determines that the forks F101 and F102 are not sufficiently inserted and the container 20 cannot be appropriately gripped.

It should be noted that, when the insertion distance dₚ is greater than the threshold value TH2, the work management device 1 may determine that the amount of insertion is inappropriate. That is, the work management device 1 determines that the forks F101 and F102 are inserted too much and the container 20 cannot be appropriately gripped. In these cases, the work management device 1 determines that the forks F101 and F102 are not allowed to be raised or lowered.

FIG. 8A is a diagram in a case in which TH1≤dₚ₃≤TH2. In the case of FIG. 8A, the forks F101 and F102 are sufficiently inserted, and the container 20 can be appropriately gripped. It should be noted that, for example, the threshold value TH1 is a value greater than a depth (a length in the Y-axis direction) of the container 20 (or the fork pockets 201 and 202).

FIG. 8B is a diagram in a case in which dₚ₃<TH1. In the case of FIG. 8B, the forks F101 and F102 may not be sufficiently inserted, and the container 20 may not be appropriately gripped (for example, the container 20 is dropped forward).

It should be noted that the work management device 1 may perform the first amount-of-insertion determination when the forks F101 and F102 are inserted into the container 20 (for example, when the forklift F1 is moving forward). The work management device 1 may not perform the first amount-of-insertion determination when the forks F101 and F102 are pulled out from the container 20 (for example, when the forklift F1 is moving backward). Further, the work management device 1 may perform the first amount-of-insertion determination when an operation for raising and lowering the lift is performed.

The work management device 1 performs a second amount-of-insertion determination below.

When the insertion distance d_{c} is 0 or when the reaching distance d_{c} is equal to or greater than a threshold value TH3 (≥0), the work management device 1 determines that the amount of insertion is appropriate (the amount of insertion is zero or negative, that is, the fork is appropriately pulled out).

In this case, the work management device 1 determines that the forks F101 and F102 are completely pulled out and appropriately separated from the container 20. Further, the work management device 1 determines that a steering operation (a handle operation) of the forklift F1 is allowed.

When the insertion distance d_{c} is greater than 0, the work management device 1 determines that the amount of insertion is inappropriate. In this case, the work management device 1 determines that the forks F101 and F102 are not completely pulled out and are not appropriately separated from the container 20. Further, the work management device 1 determines that the steering operation (the handle operation) of the forklift F1 is not allowed.

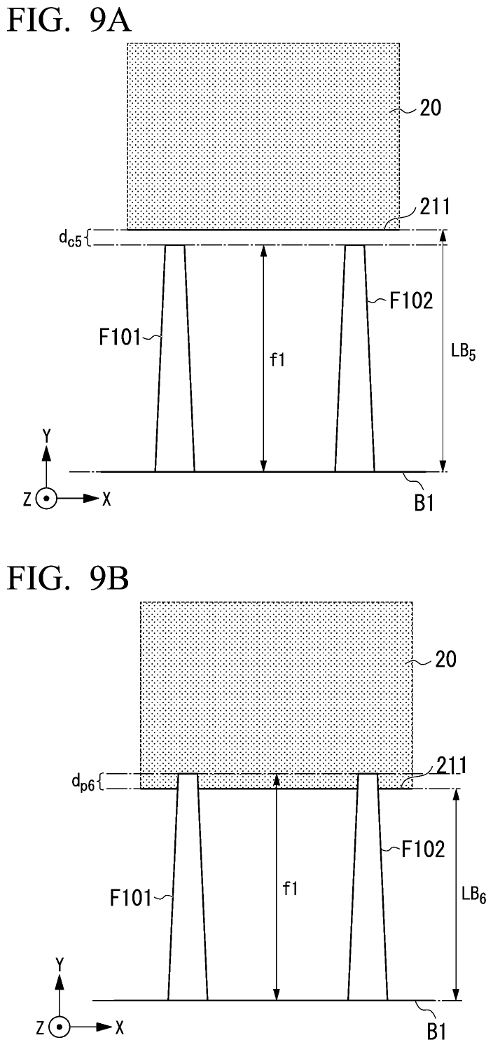

FIGS. 9A and 9B are schematic diagrams illustrating an example of the amount-of-insertion determination according to the embodiment.

FIG. 9A is a diagram in a case in which the amount of insertion is appropriate, and FIG. 9B is a diagram in a case in which the amount of insertion is inappropriate. It should be noted that FIGS. 9A and 9B are diagrams in which the sensing information is projected onto the XY plane. In FIGS. 9A and 9B, distances LB₅ and LB₆ are reference distances LB. A distance d_{c5} is a reaching distance d_{c}, and a distance dₚ₆ is the insertion distance dₚ. The fork length f1 is the length of the forks F101 and F102.

FIG. 9A is a diagram in a case in which d_{c5}≥TH3≥0. In the case of FIG. 9A, the forks F101 and F102 are completely pulled out. In this case, for example, even when the forklift F1 is bent due to a steering operation while moving backward, it is possible to prevent the forks F101 and F102 from colliding with the container 20 (or the openings of the fork pockets 201 and 202).

FIG. 9B is a diagram in a case in which dₚ₆>0. In the case of FIG. 9B, the forks F101 and F102 are not completely pulled out. In this case, for example, when the forklift F1 is bent due to a steering operation while moving backward, the forks F101 and F102 collide with the container 20 (or the openings of the fork pockets 201 and 202). For example, the work management device 1 can notify of the fact

It should be noted that the work management device 1 may perform the second amount-of-insertion determination when the forks F101 and F102 are pulled out from the container 20. On the other hand, the work management device 1 may not perform the first amount-of-insertion determination when the forks F101 and F102 are pulled out from the container 20.

Similarly, the work management device 1 may perform the first amount-of-insertion determination when the forks F101 and F102 are inserted into the container 20. On the other hand, the work management device 1 may not perform the second amount-of-insertion determination when the forks F101 and F102 are inserted into the container 20.

### <Operation of Forklift>

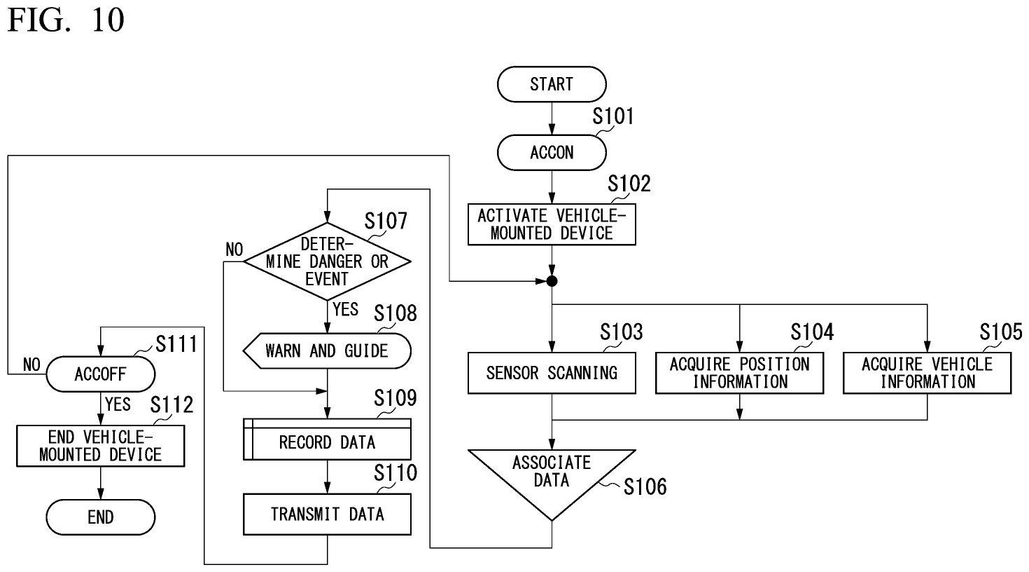

FIG. 10 is a flowchart illustrating an example of an operation of the forklift F1 according to the embodiment.

(Step S101) The forklift F1 starts up the engine through an operation of the worker or the like (ACC ON). Thereafter, the process proceeds to step S102.

(Step S102) The vehicle-mounted device such as the work management device 1 is activated by acquiring information indicating that power is supplied or the engine is started up. Then, the process proceeds to steps S103, S104, and S105.

(Step S103) The work management device 1 acquires sensing information representing a space using the spatial recognition sensor. Specifically, the work management device 1 radiates the laser light and senses the distance to the object (sensor scanning) Thereafter, the process proceeds to step S106.

(Step S104) The work management device 1 acquires position information indicating a position of the forklift F1 (the work management device 1). The position information is, for example, a positioning result of a global positioning satellite system (GNSS). However, the position information may be a positioning result using another wireless communication (for example, a wireless LAN or an RFID tag). Thereafter, the process proceeds to step S106.

(Step S105) The work management device 1 acquires vehicle information indicating a state of the forklift F1 or an operation of a worker or the like. Thereafter, the process proceeds to step S106.

Here, the vehicle information is data that the forklift F1 can output, such as a velocity, steering angle, accelerator operation, brake operation, gears (forward, backward, high velocity, low velocity, or the like), manufacturer, vehicle type, or vehicle identification information of the forklift F1. Further, the vehicle information may include a position (height) of the forks F101 and F102, the presence or absence of the gripped transport target or a weight thereof, a load situation of a lift chain, fork information indicating a types of the forks F101 and F102, or the like, identification information of a worker (a driver), identification information of a work place (a warehouse or a factory) or a company, or work information indicating identification information of a gripped (transported) transport target (for example, acquired by an RF1D attached to the transport target, or the like).

(Step S106) The work management device 1 associates the sensing information acquired in step S103, the position information acquired in step S104, and the vehicle information acquired in step S105 (associated data is also referred to as “association data”). For example, the work management device 1 associates the sensing information, the position information, and the vehicle information together with the device identification information of the work management device 1 and an acquisition date and time. Thereafter, the process proceeds to step S107.

(Step S107) The work management device 1 determines the presence or absence of a danger or an event on the basis of the association data associated in step S106. For example, the work management device 1 performs the above misalignment determination on the basis of the association data. When a determination is made that there is a danger or an event (yes), the process proceeds to step S108. On the other hand, when a determination is made that there is no danger or event (no), the process proceeds to step S109.

(Step S108) The work management device 1 outputs a warning (including guidance) on the basis of a type of danger or event determined in step S107 or data associated with the type. Thereafter, the process proceeds to step S109.

(Step S109) The work management device 1 associates the association data, determination information indicating a determination result in step S107, or output information indicating an output result of the warning in step S108 with one another, and records associated data in the recording device or the like. Thereafter, the process proceeds to step S110.

(Step S110) The work management device 1 transmits the data associated in step S109 to a server or the like. Thereafter, the process proceeds to step S111.

It should be noted that this server is, for example, an information processing device that comprehensively collects and manages data from a plurality of forklifts F1 at a work place or a company. The data transmitted to the server is analyzed using a statistical processing function or a machine learning function. The data transmitted to the server or data of an analysis result is used for driving education or the like. For example, driving data of the worker who is good at loading of the transport target or that is efficient is used as a model. On the other hand, when the transport target is damaged or dropped, data in this case is used for cause investigation or improvement.

(Step S111) When the engine of the forklift F1 is stopped due to an operation of the worker or the like (yes), the process proceeds to step S112. On the other hand, when the engine of the forklift F1 is not stopped (no), the process proceeds to steps S103, S104, and S105. That is, the work management device 1 performs the acquisition of information using sensing or the like, and the data association, recording, and transmission until the engine is stopped.

(Step S112) The vehicle-mounted device such as the work management device 1 stops or enters a sleep state by acquiring information indicating that the supply of power is stopped or the engine is stopped. Thereafter, the operation ends.

### <Configuration of Work Management Device>

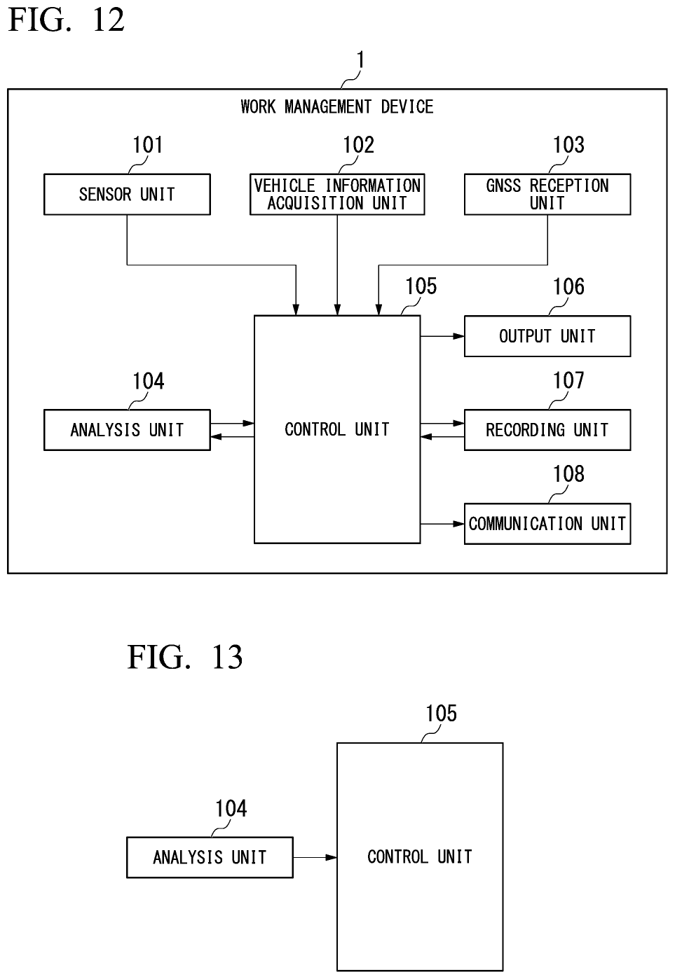

FIG. 12 is a schematic block diagram illustrating a hardware configuration of the work management device 1 according to the embodiment. In FIG. 12, the work management device 1 includes a central processing unit (CPU) 111, an interface (IF) 112, a communication module 113, a sensor 114 (for example, a spatial recognition sensor), a read only memory (ROM) 121, a random access memory (RAM) 122, and a hard disk drive (HDD) 123.

The IF 112 is, for example, a portion (a driver's seat, a vehicle body, the mast F14, or the like) of the forklift F1 or an output device (a lamp, a speaker, a touch panel display, or the like) provided in the work management device 1. The communication module 113 performs transmission and reception of signals via a communication antenna. The communication module 113 is, for example, a communication chip such as a GNSS receiver or a wireless LAN. The sensor 114, for example, radiates laser light and performs sensing based on the received reflected light.

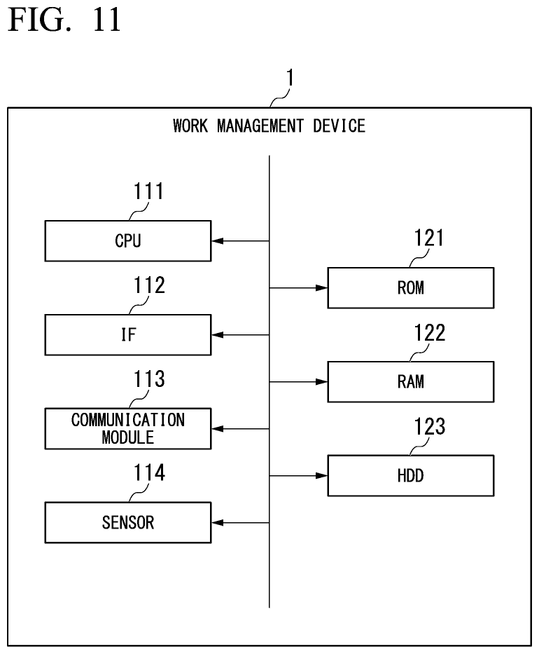

FIG. 12 is a schematic configuration diagram illustrating a hardware configuration of the work management device 1 according to the embodiment. In FIG. 11, the work management device 1 includes a sensor unit 101, a vehicle information acquisition unit 102, a GNSS reception unit 103, an analysis unit 104, a control unit 105, an output unit 106, a recording unit 107, and a communication unit 108.

The sensor unit 101 is a spatial recognition sensor. The sensor unit 101 senses the distance R from the own device to each object, for example, using laser light. The sensor unit 101 recognizes a space on the basis of an irradiation direction (the polar angles θ and ϕ) of the laser light and the sensed distance R. It should be noted that the recognition of the space means generation of three-dimensional coordinates for a space including surrounding objects, the present invention is not limited thereto and the recognition of the space ma mean generation of two-dimensional coordinates. The sensor unit 101 generates sensing information (for example, coordinate information) and outputs the sensing information to the control unit 105.

The vehicle information acquisition unit 102 acquires vehicle information from the forklift F1 and outputs the acquired vehicle information to the control unit 105.

The GNSS reception unit 103 acquires position information and outputs the acquired position information to the control unit 105.

The analysis unit 104 acquires the sensing information output by the sensor unit 101, the vehicle information output by the vehicle information acquisition unit 102, and the position information output by the GNSS reception unit from the control unit 105.

The analysis unit 104 generates association data by associating the acquired sensing information, vehicle information, and position information with one another. The analysis unit 104 analyzes the generated association data.

For example, the analysis unit 104 detects the insertion surface 211 (the container 20) by detecting the plane and the fork pockets 201 and 202 through the first detection process based on the sensing information. Further, the analysis unit 104 detects the forks F101 and F102 through the second detection process based on the sensing information. Here, the analysis unit 104 may measure the lengths of the detected forks F101 and F102.

Further, the analysis unit 104 calculates the reference distance Lᵢ for at least one point of the detected insertion surface 211 on the basis of the acquired sensing information, and determines the target distance LB. The analysis unit 104 calculates the value d obtained by subtracting the target distance LB from the fork length f1 as the insertion distance dₚ (when the value is positive or 0) or the reaching distance d_{c} (when the value is negative).

The control unit 105 acquires the sensing information output by the sensor unit 101, the vehicle information output by the vehicle information acquisition unit 102, and the position information output by the GNSS reception unit, analyzes the information using, for example, the analysis unit 104, and performs the determination on the basis of an analysis result.

For example, the control unit 105 determines the presence or absence of a danger or an event. The control unit 105 performs, as such a determination, the amount-of-insertion determination described above.

Specifically, the control unit 105 determines the amount-of-insertion determination (the first amount-of-insertion determination and the second amount-of-insertion determination) by determining whether or not the value d (the insertion distance dₚ or the reaching distance d_{c}) calculated by the analysis unit 104 is in a predetermined range.

The control unit 105 causes a warning (including guidance) to be output from the output unit 106 on the basis of the determination result or data associated with the determination result. It should be noted that the output unit 106 may output information based on the type of displacement or the amount of displacement.

The control unit 105 records determination information indicating and data associated with the determination result on the recording unit 107 and transmits the determination information and the association data to a server or the like via the communication unit 108.

It should be noted that the sensor unit 101 is realized by the sensor 114 in FIG. 11. Similarly, the vehicle information acquisition unit 102 and the GNSS reception unit 103 are realized by the communication module 113, for example. The analysis unit 104 and the control unit 105 are realized by, for example, a CPU 111, a ROM 121, a RAM 122, or an HDD 123.

### Conclusion of Embodiment

As described above, in the embodiment, the work management device 1 is a vehicle-mounted device mounted in the forklift F1 (the cargo handling machine). In the work management device 1 (the forklift H), as illustrated in FIG. 13, the analysis unit 104 detects the forks F101 and F102 (insertion blades) on the basis of the sensing information that the analysis unit 104 has acquired from the spatial recognition sensor (a spatial recognition device), and calculates an insertion distance dₚ indicating a distance by which the detected forks F101 and F102 are inserted into the container 20 (the insertion target). The control unit 105 performs the amount-of-insertion determination to determine whether or not the insertion distance dₚ is in a predetermined range.

Accordingly, the work management device 1 can insert the forks F101 and F102 into the fork pockets 201 and 202 by an appropriate distance and can appropriately transport the transport target. For example, the forklift F1 can grip and transport the container 20 appropriately (with a good balance and stability) and can prevent the container 20 from being dropped due to, for example, the insufficient amount of insertion. Further, the work management device 1 can prevent the object (another container or the like) inside the container 20 from being damaged or reversed. Further, the work management device 1 can prevent the forks F101 and F102 from colliding with the container 20 due to the steering operation (a handle operation) when the forks F101 and F102 are not completely pulled out after the container 20 is placed on the loading platform L1, or the like.

Further, in the embodiment, in the work management device 1 (the forklift F1), the analysis unit 104 calculates the insertion distance dₚ on the basis of the distance indicated by the sensing information, which is the reference distance LB from the position of the base of the forks F101 and F102 or the vicinity thereof to the opening of the insertion target. For example, the analysis unit 104 subtracts the reference distance LB from the fork length f1.

Accordingly, the work management device 1 can calculate the insertion distance dₚ on the basis of the distance indicated by the sensing information and can perform the amount-of-insertion determination using the sensing information.

### <Modification Example A1>

In the above embodiment, the analysis unit 104 (the forklift F1 or the work management device 1) may calculate the insertion distance dₚ on the basis of a timing at which the forks F101 and F102 (the distal ends of the forks) have reached the position indicated by the sensing information, which is the position of the openings of the fork pockets 201 and 202 of the container 20 (also referred to as a “reaching timing”) and a velocity of the forklift F1.

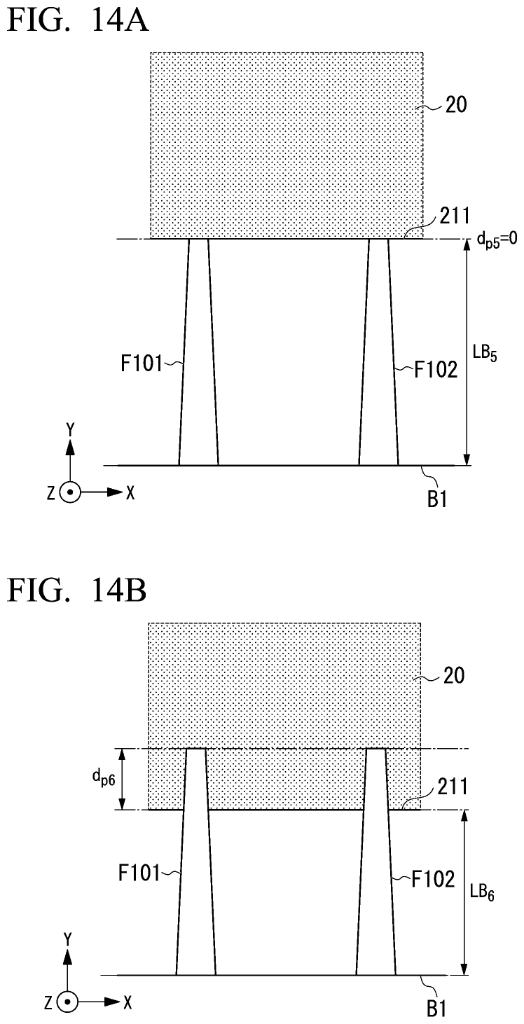

FIGS. 14A and 14B are schematic diagrams illustrating an example of an amount-of-insertion determination according to a modification example of the embodiment.

FIG. 14A is a diagram illustrating a positional relationship between the forks F101 and F102 at a timing when the forks F101 and F102 have reached the insertion surface 211 of the container 20, and FIG. 14B is a diagram illustrating a positional relationship between the forks F101 and F102 at a timing after the forks F101 and F102 have reached the insertion surface 211. It should be noted that FIGS. 14A and 14B are diagrams in which the sensing information is projected onto the XY plane. In FIGS. 14A and 14B, distances LB₅ and LB₆ are reference distances LB, and distances dₚ₅(=0) and dₚ₆ are insertion distances dₚ. The fork length f1 is the length of the forks F101 and F102.

Specifically, the analysis unit 104 detects a point in time at which the value d obtained by subtracting the target distance LB from the fork length f1 becomes 0 (the insertion distance dₚ=the reaching distance d_{c}=0), as a reaching timing of the forks F101 and F102 (for example, FIG. 14A). It should be noted that, when the forklift F1 is moving forward on the basis of the vehicle information, the analysis unit 104 may set a point in time at which the value d becomes 0, as the reaching timing.

This vehicle information is, for example, vehicle information indicating a forward movement gear, or vehicle information indicating that a movement direction indicates a forward direction (a rotation direction of a tire).

The analysis unit 104 calculates the insertion distance dₚ by integrating a velocity (which may be a velocity in the Y-axis direction) with time from the reaching timing. For example, when a time Δt has elapsed when the velocity v is constant, the analysis unit 104 calculates the insertion distance dₚ=v×Δt.

It should be noted that, when the vehicle information includes information indicating the number of rotations of the tire and a circumference of the tire, the analysis unit 104 calculates the insertion distance dₚ as the circumference of the tire×(the number of rotations of the tire after the reaching timing).

In the modification example, for example, after the reaching timing, the analysis unit 104 can calculate the insertion distance dₚ without using the distance LB or the fork length f1.

### <Modification Example A2>

In the above embodiment, the analysis unit 104 (the forklift F1 or the work management device 1) may calculate the insertion distance dₚ on the basis of a difference between the distance LB from the spatial recognition sensor (the work management device 1) to the insertion surface 211 when the forks F101 and F102 (the distal ends of the forks) have reached the position indicated by the sensing information, which is the position of the openings of the fork pockets 201 and 202 of the container 20, and the distance LB from the spatial recognition sensor to the insertion surface 211 after reaching the position.

For example, in FIGS. 14A and 14B, the analysis unit 104 calculates the insertion distance dₚ₆ by subtracting the distance L_{B6} from the spatial recognition sensor to the insertion surface 211 after the forks F101 and F102 reach the positions of the openings of the fork pockets 201 and 202, from the distance LB₅ from the spatial recognition sensor to the insertion surface 211 when the forks F101 and F102 reach the positions of the openings of the fork pockets 201 and 202.

In the modification example, for example, after the reaching timing, the analysis unit 104 can calculate the insertion distance dₚ without using the fork length f1.

### <Modification Example A3>

In the above embodiment, the control unit 105 (the forklift F1 or the work management device 1) may change the output based on the amount-of-insertion determination, on the basis of the insertion distance dₚ.

Specifically, when the control unit 105 determines that the amount of insertion is inappropriate, the control unit 105 may change a magnitude or frequency of the output according to whether the amount of insertion approaches (or moves away from) a range determined for the amount of insertion to be appropriate. Accordingly, the work management device 1 can output a change in the insertion distance dₚ, in addition to the determination result of the amount-of-insertion determination.

For example, when the control unit 105 determines that the amount of insertion is inappropriate, the control unit 105 increases a frequency of the output (for example, sound) when the amount of insertion approaches the range determined for the amount of insertion to be appropriate or when the amount of insertion moves away from the range determined for the amount of insertion to be appropriate. In this case, the control unit 105 may stop the output, may perform an output different from that in the case in which the amount of insertion is inappropriate, or may stop the output after this output when a determination result of the amount-of-insertion determination changes (changes from inappropriate to appropriate). Accordingly, the work management device 1 can notify the worker or the like whether or not the insertion distance dₚ has correctly changed in order to change the determination result of the amount-of-insertion determination, for example.

Further, for example, when the control unit 105 determines that the amount of insertion is inappropriate and the insertion distance dₚ is greater than a predetermined value, the control unit 105 may perform a warning with a less noticeable warning (a lower output, such as a lower sound or darker light, a shorter time or a smaller number of times of pulsing of a sound or light, or a wider interval of pulsing of a sound or light), as compared with a case in which the insertion distance dₚ is smaller than the predetermined value. On the other hand, when the control unit 105 determines that the amount of insertion is inappropriate and the insertion distance dₚ is smaller than the predetermined value, the control unit 105 performs a warning with a more noticeable warning (a higher output, such as a higher sound or brighter light, a longer time or a larger number of times of pulsing of a sound or light, or a narrower interval of pulsing of a sound or light), as compared with a case in which the insertion distance dₚ is greater than the predetermined value.

### <Modification Example A4>

In the above embodiment, the control unit 105 (the forklift F1 or the work management device 1) may also cause a warning to be output on the basis of a result of the amount-of-insertion determination and a traveling direction of the vehicle in which the own device is mounted. In this case, the output unit 106 outputs the warning on the basis of the result of the amount-of-insertion determination and the traveling direction of the vehicle in which the own device is mounted.

Specifically, when the control unit 105 determines that the amount of insertion is inappropriate (the insertion distance dₚ is smaller than the threshold value TH1), the control unit 105 outputs a warning in a case in which the traveling direction is a backward direction. In this case, when the traveling direction is a forward direction, the control unit 105 may not output a warning. Further, the control unit 105 may output a warning in a case in which the traveling direction changes from forward to backward when the control unit 105 determines that the amount of insertion is inappropriate (the insertion distance dₚ is smaller than the threshold value TH1).

For example, when the forklift F1 transports the container 20, the forklift F1 moves forward so that the forks F101 and F102 are inserted into the container 20, grips the container 20, usually first moves backward, and transports the container 20. That is, when the forks F101 and F102 move backward, it is necessary to appropriately insert the forks F101 and F102 (it is necessary for the amount of insertion to be appropriate). In the modification example, since the work management device 1 outputs the warning when the traveling direction is a backward direction, the work management device 1 can output the warning when it is necessary to appropriately grip the transport target.

### <Modification Example A5>

In the above embodiment, the control unit 105 (the forklift F1 or the work management device 1) may output a warning on the basis of a result of the amount-of-insertion determination and vehicle information indicating a lift operation of the vehicle in which the own device is mounted.

Specifically, the work management device 1 may perform the amount-of-insertion determination when an operation for raising and lowering the lift is performed. For example, the work management device 1 may perform the first amount-of-insertion determination when an operation of raising the lift (moving the lift in the Z-axis positive direction) is performed. On the other hand, the work management device 1 performs the first amount-of-insertion determination for a specific period (a period until there is a specific movement) after the operation for lowering the lift (moving the lift in a negative direction of the Z axis) is performed.

### <Modification Example A6>

In the above embodiment, the control unit 105 (the forklift F1 or the work management device 1) may perform the output on the basis of a first determination result or a second determination result, and the vehicle information.

Specifically, the control unit 105 causes the warning to be output on the basis of the result of the amount-of-insertion determination and the traveling direction of the vehicle in which the own device is mounted.

For example, when the control unit 105 determines that the insertion is inappropriate in the first amount-of-insertion determination, the control unit 105 may output a warning in a case in which the vehicle information indicates that the traveling direction of the forklift F1 is a backward direction. On the other hand, when the control unit 105 determines that the insertion is inappropriate in the second amount-of-insertion determination, the control unit 105 may not output a warning in a case in which the vehicle information indicates that the traveling direction of the forklift F1 is the backward direction.

Here, the case in which the traveling direction of the forklift F1 indicates the backward direction is, for example, a case in which the gear is in a backward movement or a case in which the gear is in a backward movement and the forklift F1 starts to moves in the backward direction.

Further, for example, when the control unit 105 determines that the insertion is inappropriate in the second amount-of-insertion determination, the control unit 105 may output a warning in a case in which the vehicle information indicates that the traveling direction of the forklift F1 is the forward direction. On the other hand, when the control unit 105 determines that the insertion is inappropriate in the first amount-of-insertion determination, the control unit 105 may not output the warning in a case in which the vehicle information indicates that the traveling direction of the forklift F1 is the forward direction.

Further, for example, when a determination is made that the insertion is inappropriate in the first determination result or the second determination result, the control unit 105 may output a warning in a case in which it is indicated that the forklift F1 is to be turned. Here, an example of the case in which it is indicated that the forklift F1 is to be bent is a case in which the steering angle indicated by the vehicle information is equal to or greater than the threshold value or a case in which the steering angle indicated by the vehicle information is equal to or greater than the threshold value and the forklift F1 starts to move backward.

### <Modification Example A7>

In the above embodiment, the control unit 105 (the forklift F1 or the work management device 1) may determine whether or not the forks are facing the insertion surface 211 having the openings of the fork pockets 201 and 202 on the basis of the sensing information, and then, perform the amount-of-insertion determination or a warning based on the amount-of-insertion determination (also referred to as “amount-of-insertion determination or the like”).

Further, the control unit 105 may determine whether or not the positional relationship between the fork pockets 201 and 202 and the forks F101 and F102 is misaligned on the basis of the sensing information (also referred to as a “misalignment determination”), and then, perform the amount-of-insertion determination or the like. It should be noted that the misalignment determination is to determine whether or not the forks F101 and F102 are included in a range of the fork pockets 201 and 202 in the projection of the XZ plane.

The control unit 105 may perform the misalignment determination after performing the facing determination, and then perform the amount-of-insertion determination or the like. Accordingly, the work management device 1 can cause the forklift F1 to be facing, the forks F101 and F102 to be inserted into the fork pockets 201 and 202 without a misalignment, and the forks F101 and F102 to be inserted by the appropriate insertion distance dₚ.

### <Modification Example A8>

In the above embodiment, when the forks F101 and F102 are inserted, the analysis unit 104 (the forklift F1 or the work management device 1) may calculate the amount by which the distal end of the forks F101 and F102 protrudes from a back surface of the container 20 (also referred to as a “amount of protrusion”).

Specifically, the analysis unit 104 stores the length A in the depth direction (Y-axis direction) of the container 20 in advance or calculates the length A according to a detection result of the spatial recognition sensor. The analysis unit 104 sets a value obtained by subtracting A from the insertion distance dₚ as the amount of protrusion.

When the amount of protrusion calculated by the analysis unit 104 is equal to or greater than a threshold value, the control unit 105 determines that the protrusion is too large and outputs a warning. On the other hand, when the amount of protrusion calculated by the analysis unit 104 is negative (the forks do not protrude) and is equal to or smaller than a threshold value (is negative), the control unit 105 may determine that the insertion is insufficient and output a warning.

### <Modification Example B1: Condition of Output or Amount-of-Insertion Determination>

In the above embodiment, the control unit 105 (the forklift F1 or the work management device 1) may set a condition for performing the amount-of-insertion determination or not.

The control unit 105 may perform a warning based on the amount-of-insertion determination when a first condition below is satisfied, and may not perform the warning based on the amount-of-insertion determination when the first condition is not satisfied.

Further, the control unit 105 may perform the amount-of-insertion determination or the sensing when the first condition is satisfied, and may not perform the amount-of-insertion determination or the sensing when the first condition is not satisfied.

Further, the control unit 105 may change an interval of the warning based on the amount-of-insertion determination, the amount-of-insertion determination, or the sensing (hereinafter referred to as a warning or the like) on the basis of the first condition.

The first condition is, for example, a condition that a distance between the container 20 and the forklift F1 (for example, the reference distance Lᵢ or the target distance LB) is smaller than (close to) a threshold value.

The first condition may be, for example, a condition based on position information or vehicle information. For example, when the forklift F1 enters a predetermined position (range) in a warehouse or the like, the control unit 105 may perform the warning or the like and may not perform the warning or the like at other positions.

The first condition may be, for example, a condition based on fork information or work information.

For example, the control unit 105 may perform the warning or the like when there is no gripped transport target and may not perform the warning or the like when there is an gripped transport target. The control unit 105 may perform the warning or the like when the position (height) of the forks F101 and F102 is lower than a threshold value, and may not perform the warning or the like when the position (height) of the forks F101 and F102 are higher than the threshold value.

For example, the control unit 105 may perform the warning or the like when a specific worker drives, and may not perform the warning or the like in other cases.

It should be noted that, as illustrated in FIG. 2, in a case in which the work management device 1 is fixed to a central portion of the forklift F1 in an X-axis direction, the work management device 1 can be located in a central portion of the fork F101 and the fork F102 or a central portion of the fork pocket 201 and the fork pocket 202 when the forklift F1 tries to grip the container 20 appropriately.

Further, when the work management device 1 is fixed to the fork rail F11 or the backrest F13, the work management device 1 can more easily recognize the forks F101 and F102, as compared to a case in which the work management device 1 is fixed to the fork rail F12. That is, since the work management device 1 and the forks F101 and F102 are separated in a height direction (the X-axis direction), the work management device 1 can further recognize shapes in a length direction (the Y-axis direction) of the forks F101 and F102 (see FIGS. 3 and 5).

Further, the work management device 1 can sense the forks F101 and F102 (particularly up to a base portion) when the work management device 1 is fixed to the lower surface side (lower side) of the fork rail F11 or the like.

Further, when the work management device 1 is fixed to the fork rail F11 or F12, the work management device 1 can more easily recognize the fork pockets 201 and 202, as compared to a case in which the work management device 1 is fixed to the backrest F13. That is, since the work management device 1 and the fork pockets 201 and 202 approach in the height direction, the work management device 1 can cause an irradiation angle (an angle in the height direction) of the laser light or the like to the fork pockets 201 and 202 to be further close to horizontal (perpendicular to the insertion surface).

The spatial recognition sensor may perform spatial recognition using means other than the laser light. For example, the work management device 1 may perform spatial recognition using radio waves other than laser light, or may perform the spatial recognition using a captured image, for example. Examples of the spatial recognition sensor may include a monocular camera, a stereo camera, an infrared camera, a millimeter wave radar, an optical laser, a light detection and ranging or laser imaging detection and ranging (LiDAR), and an (ultra) sonic wave sensor.

Further, the work management device 1 may be connected to an automatic driving device, or may be a part of the automatic driving device. That is, the work management device 1 may perform the amount-of-insertion determination to automatically drive the forklift F1 so that the amount of insertion becomes appropriate.

For example, the work management device 1 adjusts a gear, an accelerator, and a brake so that the insertion distance dₚ approaches a predetermined range as a result of the amount-of-insertion determination, and causes, for example, the forklift F1 to move forward or backward.

Further, the work management device 1 may exclude the road surface G, a wall, and an object at a position farther than a predetermined distance from the detection targets (sensing information). When projection onto each surface is performed, the work management device 1 excludes these from projection targets.

It should be noted that the work management device 1 may use edge detection when detecting the container 20, and the forks F101 and F102. Here, an edge detected using edge detection is, for example, the distance R or a place at which a rate of change thereof is large.

As a specific edge detection, the work management device 1 may use, as an edge, a portion in which a partial differential on each coordinate axis is equal to or greater than a threshold value for the detected object. Further, for example, the work management device 1 may use, as an edge, a portion in which detected planes intersect, a portion in which a difference in distance R between adjacent or close points in the reverse direction is equal to or greater than a threshold value, or a portion adjacent to a portion in which reflected light of laser light is not detected, or a portion adjacent to a portion in which a reception level of the reflected light of the laser light is low. The work management device 1 may perform edge detection using another scheme.

It should be noted that the work management device 1 may perform the above process by recording a program for realizing each function in a computer-readable recording medium, loading the program recorded on the recording medium into the computer system, and executing the program. It should be noted that the “computer system” described herein includes an OS or hardware such as a peripheral device. Further, the “computer system” also includes a WWW system including a homepage providing environment (or display environment). Further, the “computer-readable recording medium” includes a storage device such as a flexible disk, a magneto-optical disc, a read only memory (ROM), a portable medium such as a CD-ROM, or a hard disk built in the computer system. Further, the “computer-readable recording medium” also includes a recording medium that holds a program for a certain time, such as a volatile memory (RAM) inside a computer system including a server and a client when a program is transmitted over a network such as the Internet or a communication line such as a telephone line.

Further, the program may be transmitted from a computer system in which the program is stored in a storage device or the like to other computer systems via a transfer medium or by transfer waves in the transfer medium. Here, the “transfer medium” for transferring the program refers to a medium having a function of transferring information, such as a network (communication network) such as the Internet or a communication line such as a telephone line. Further, the program may be a program for realizing some of the above-described functions. Further, the program may be a program capable of realizing the above-described functions in combination with a program previously stored in the computer system, that is, a so-called differential file (differential program).

Priority is claimed on Japanese Patent Application No. 2017-56012, filed Mar. 22, 2017, the content of which is incorporated herein by reference.

### REFERENCE SYMBOLS

F1 Forklift

F101, F102 Fork

F11 , F12 Fork rail

F13 Backrest

F14 Mast

20 Container

201, 202 Fork pocket

211 Insertion surface

1 Work management device

111 CPU

112 IF

113 Communication module

114 sensor

121 ROM

122 RAM

123 HDD

101 Sensor

102 Vehicle Information acquisition Unit

103 GNSS receiver

104 Analysis unit

105 Control unit

106 Output unit

107 Recording unit

108 Communication unit

1. A vehicle-mounted device comprising:
an analysis unit that detects an insertion blade on the basis of sensing information acquired from a spatial recognition device, and calculates an insertion distance indicating a distance by which the detected insertion blade is inserted into an insertion target; and
a control unit that performs an amount-of-insertion determination to determine whether or not the insertion distance is in a predetermined range.

2. The vehicle-mounted device according to claim 1, wherein the analysis unit calculates the insertion distance on the basis of a distance indicated by the sensing information, the distance being a distance from a position of a base of the insertion blade or the vicinity thereof to an insertion portion of the insertion target.

3. The vehicle-mounted device according to claim 1, wherein the analysis unit calculate the insertion distance on the basis of a timing at which the insertion blade has reached a position indicated by the sensing information, the position being a position of the insertion portion of the insertion target, and a velocity of a vehicle in which the vehicle-mounted device is mounted.

4. The vehicle-mounted device according to claim 1, wherein the analysis unit calculates the insertion distance on the basis of a difference between a distance from the spatial recognition device to the insertion surface when the insertion blade has reached a position indicated by the sensing information, the position being a position of the insertion portion of the insertion target, and a distance from the spatial recognition device to the insertion surface after the insertion blade has reached the position of the insertion portion.

5. The vehicle-mounted device according to claim 1, wherein the control unit changes an output based on the amount-of-insertion determination, on the basis of the insertion distance.

6. The vehicle-mounted device according to claim 1, wherein the control unit causes a warning to be output on the basis of a result of the amount-of-insertion determination and a traveling direction of a vehicle in which the own device is mounted.

7. A cargo handling machine comprising the vehicle-mounted device including:
an analysis unit that detects an insertion blade on the basis of sensing information acquired from a spatial recognition device, and calculates an insertion distance indicating a distance by which the detected insertion blade is inserted into an insertion target and
a control unit that performs an amount-of-insertion determination to determine whether or not the insertion distance is in a predetermined range.

8. A control circuit that detects an insertion blade on the basis of sensing information acquired from a spatial recognition device, and determines whether or not an insertion distance indicating a distance by which the detected insertion blade is inserted into an insertion target is a predetermined range.

9. A control method comprising:
detecting, by an analysis unit, an insertion blade on the basis of sensing information acquired from a spatial recognition device, and calculating an insertion distance indicating a distance by which the detected insertion blade is inserted into an insertion target; and
performing, by a control unit, an amount-of-insertion determination to determine whether or not the insertion distance is in a predetermined range.

10. A non-transitory computer readable medium which stores a program causing a computer to:
detect an insertion blade on the basis of sensing information acquired from a spatial recognition device;
calculate an insertion distance indicating a distance by which the detected insertion blade is inserted into an insertion target; and
perform an amount-of-insertion determination to determine whether or not the insertion distance is in a predetermined range.
